(19) United States
(12) Patent Application Publication
(10) Pub. No.: US 2024/0125668 A1
(43) Pub. Date: Apr. 18, 2024

(54) High Voltage Leak Testing Method and Device

(71) Applicant: Danny de Bruyn, Ophasselt (BE)

(72) Inventor: Danny de Bruyn, Ophasselt (BE)

(21) Appl. No.: 18/477,659

(22) Filed: Sep. 29, 2023

(30) Foreign Application Priority Data
Sep. 30, 2022 (NO) 20221047

(51) Int. Cl. G01M 3/40

(52) U.S. Cl. CPC G01M 3/40

(57) ABSTRACT

A method and device for leak testing of blow molded plastic containers uses high voltage in order to check at least one container wall which separates an outside of the container from an inside of the container for micro cracks or pinholes by placing a first electrode on the outside of the container wall and a second electrode on the inside of the container wall. High voltage is then applied between the first and the second electrode, and a current between the first and the second electrode is detected and compared to a predetermined threshold. A container is disposed if the detected current is above a pre-determined threshold. The first electrode is the anode and the second electrode is the cathode.

### BACKGROUND

The disclosed embodiments relate to a method for the leak testing of blow molded containers, and a related device.

Leak testing of blow molded bottles and other containers is essential for providing bottles and containers of high quality. Leak in containers may on the one hand lead to leaching of contained substance. On the other hand, oxygen may penetrate the protective barrier which a blow molded container represents for foodstuff or beverage. Presence of oxygen leads to loss of quality and frequently to the total loss of food or beverage products. Leak testing before the container is used in packaging applications is therefore an important task in order to avoid significant economic and ecological loss. Different methods for leak testing are known. Widely used are methods wherein an empty container is pressurized for a very short period of time, sealed and the pressure drop observed. The presence of a leak leads to an inacceptable high pressure drop and the container is discarded. EP3809108 B1 discloses a leak tester, which can test several thousand blow molded bottles right after the blow molding process. One disadvantage with pressure drop measurements is that the leak needs to be present during the test. Sometimes containers pass a pressure drop leak test, but are unusable for foodstuff or beverage, because the leak is formed during the filling process at a weak position of the container. Weak positions may be detected by application of high voltage through possible weak positions in a container such as micro cracks or pinholes in bottom parts in extrusion blow molded containers.

JP2006337064 A2 discloses methods for controlling the sealing of the cap of a container. Two electrodes are externally associated to the container applying a high voltage in a sinusoidal regime, verifying the presence of micro-holes from the measurements of the current intensity which passes between the electrodes following the application of such voltage at sinusoidal regime. The drawback is that the use of sinusoidal voltage requires a complex and expensive electronics system and a high energy consumption.

U.S. Pat. No. 4,243,932 A and EP2365309 B1 disclose methods and systems for checking sealed containers with contents enclosed therein for pinholes by placing a sealed container between first and second electrodes impressing voltage across the first electrode and second electrodes to generate and measure discharge current flows. A high energy consumption is required.

A continuous system for high voltage leak detection is shown on https://www.youtube.com/watch?v=aUDcfBYUCHM&ab_channel=AntaresVision. The bottles are not in contact with each other.

Another example for a high voltage leak tester for automatic leak testing of micro cracks in the bottom of PET (polyethylene terephthalate) bottles is disclosed on https://delta-engineering.be/high-voltage-leak-tester. Extremely sensitive measurements and easy setup makes testing of several thousands of bottles per hour in line after a blow molding machine feasible. Due to practical reasons the anode of the high voltage leak detector is place inside the bottle and the cathode on the outside. Micro cracks are detected by measuring the current between anode and cathode through the bottom of the bottle. Typically, 8 kV/0.1 mm are applied.

The drawback of having the cathode on the outside is that the outside of blow molded plastic containers is negative charged, which leads to attraction between the containers, damaged surfaces and even blocking on the line. These negative effects may be partly overcome by spray coating the surface of the containers with tiny amounts of substances providing a moisture film on the surface. However, these substances are expensive and an increased dosage may be the consequence of the surface charging in the high voltage leak tester.

It is therefore a need for a high voltage leak tester which does not involve surface damage of blow molded plastic containers and which does not lead to decreased productivity due to blocking of the line.

### SUMMARY

Provided herein is a method and device for high voltage leak testing which does not increase the amount of negative charges on the outside of blow molded plastic containers.

According to the disclosure, a method for leak testing of blow molded plastic containers uses high voltage in order to check at least one container wall for micro cracks or pinholes. The container wall separates an outside of the container from an inside of the container. A first electrode is placed on the outside of the container wall and a second electrode on the inside of the container wall. Then a high voltage is applied between the first and the second electrode. If the container wall is free for micro cracks or pin holes, only a negligible current is detected. If micro cracks or pin holes are present in the container wall, a significantly increased current is detected, since the dielectric properties of the container wall are weakened and electrons may propagate through the detecting a cracks or holes in the container wall. A maximum current is pre-determined as a threshold. If the detected current exceeds the threshold, the cracks or holes are not negligible and the container is in danger to leach filled goods or to fail to preserve the filled goods from oxygen. It is essential, that the first electrode is the cathode and the second electrode is the anode in order to avoid negative electric charges on the outside of the container. Such negative charges lead to attraction between the containers, damaged surfaces and even blockings on the line, if the leak testing system is arranged for leak testing of a continuous flow of blow molded containers.

In one embodiment the container wall has a thickness in the range 0.3 to 3.0 mm, more preferred in the range 0.4 to 2 mm and most preferred 0.5 to 1 mm.

In another embodiment the container wall comprises a thermoplastic material selected from the group consisting of polyethylene terephthalate (PET), high density polyethylene (HDPE), polypropylene (PP). Negative charges leading to attraction between the containers, damaged surfaces and blockings on the line are frequently observed with PET.

In another embodiment the container wall comprises at least one barrier layer selected from the group consisting of gas barrier layer, solvent barrier layer, fragrance barrier layer and any combinations thereof. Barrier layers are usually made of different materials then thermoplastic materials such as PET, HDPE or PP. Materials such as polyamide (PA) or ethylene vinyl alcohol copolymer (EVOH) are frequently used as barrier materials. Good adhesion is essential for providing the expected barrier. Thermoplastic resins grafted with maleic anhydride or acrylic acid may be used at adhesion promotors between the barrier layer and the thermoplastic resin. Failure in the adhesion between different layers in the container wall may facilitate the formation of cracks and holes.

In yet another embodiment the container wall may comprise one or more types of fillers or one or more types of fibres. Fillers and fibres may be used to strengthen the wall of the container or to substitute thermoplastic resin with material of lower cost. Good adhesion between fillers or fibres and the thermoplastic resin serving as matrix is essential in order to avoid cracks and holes.

In another embodiment the negative surface charge on the outside of a checked container may be lower than the negative surface charge on the outside of a non-checked container. This is the case when the anode on the outside of the container wall impairs the formation of negative charges on the outside of the container wall.

In another embodiment the applied voltage is less than 10 kV/0.1 mm, preferably less than 8 kV/0.1 mm and especially preferred less than 5 kV/0.1 mm. Lower voltage can be applied with less costly components and energy may be saved. On the other hand, the sensitivity of the leak tester and thereby the discernment between acceptable and non-acceptable containers may be impaired.

A device may be designed for leak testing of blow molded containers by using high voltage. The device is designed to check at least one container wall which separates an outside of the container from an inside of the container for micro cracks or pinholes. The device is designed for placing a first electrode on the outside of the container wall and a second electrode on the inside of the container wall followed by applying a high voltage between the first and the second electrode, detecting a current between the first and the second electrode and disposing the container if the detected current is above a pre-determined threshold. The device is designed with the first electrode as the anode and the second electrode as the cathode.

### BRIEF DESCRIPTION OF THE DRAWINGS

Below, the invention will be descried in further detail in the form of non-limiting exemplary embodiments illustrated by drawings, where:

FIG. 1A is a simplified, schematic side view of an arrangement in accordance with the disclosure in a first position;

FIG. 1B is a simplified, schematic side view of an arrangement in accordance with the disclosure in a second position;

FIG. 2 is a simplified, schematic side view of an arrangement not in accordance with the disclosure in a position similar to FIG. 1B; and

FIG. 3 is an illustration of two measurements according to the disclosure, a first one of a product in compliance with the product specification and a second one not in compliance with the product specification.

### DETAILED DESCRIPTION

Certain means and devices described herein for performing steps of the inventive method are not described in detail herein since they are somewhat conventional in this technical field. For example, the disclosed embodiments may use elements such as actuators for moving electrodes and containers; sensor(s) for measuring properties; receiver(s) for receiving measurements or other data transmitted by another element; processor(s) for calculating and comparing data; data storage; display unit(s) for displaying data; measurements and instructions; and communication lines between such elements. The novelty and inventiveness of the disclosed method and device are inherent in the relationships and the specific way with which means and devices are combined and used.

By schematic is understood that the shape and proportions shown may be significantly different from real-life equipment, though still illustrating the general principle of the inventive embodiments disclosed herein. It is understood that additional equipment that typically will be present in a real-life plant is omitted for reasons of simplicity.

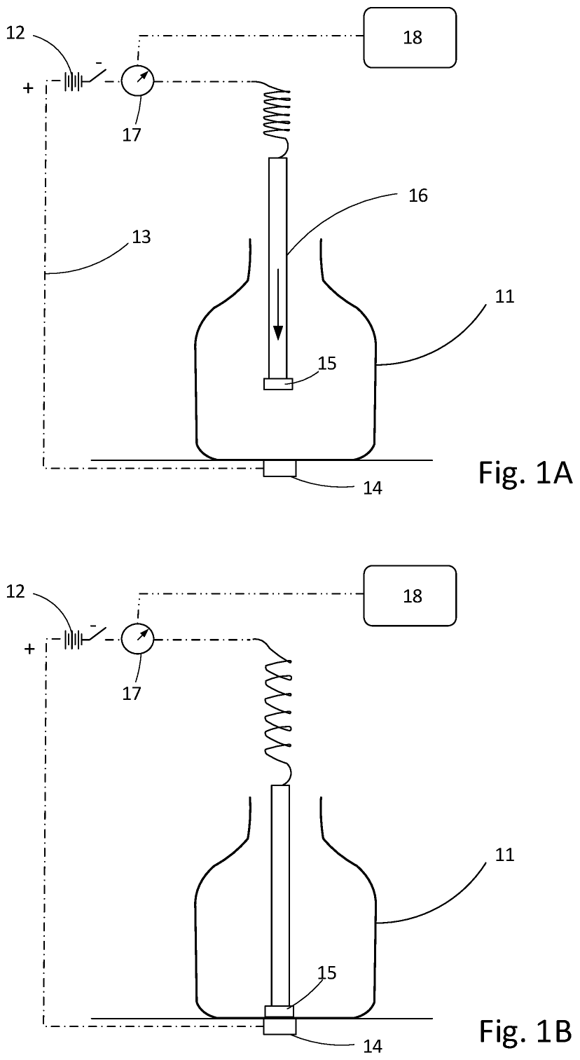

FIG. 1A is a simplified schematic side view of a “snap shot” of a testing procedure according to the present invention. A plastic container 11 is about to be tested and the testing equipment comprises a direct current supply 12, electric conductors 13, a first electrode 14 arranged outside the container, and a second electrode 15 arranged on a movable rod 16, configured to enter the container opening and to bring the second electrode adjacent to the first electrode. A measurement device 17 is connected in the electric circuit to measure the relation between voltage and current and a computer device 18 receives signals from the measurement device 17 in order to determine compliance or non-compliance with product specification for the container in question. The “snap shot” of FIG. 1A represents when the rod 16 is bringing the second electrode 15 downwards into the container, immediately before a measurement is taking place.

The first electrode 14 is the anode connected to the positive side of the direct current source 12 while the second electrode 15 is the cathode connected to the negative side of the direct current source.

FIG. 1B shows the same arrangement as FIG. 1A in the measuring position, i.e. when the second electrode 15 is brought down to the bottom of the container adjacent to the first electrode 14. Measurement can be performed very rapidly once this position is reached, typically within fractions of a second.

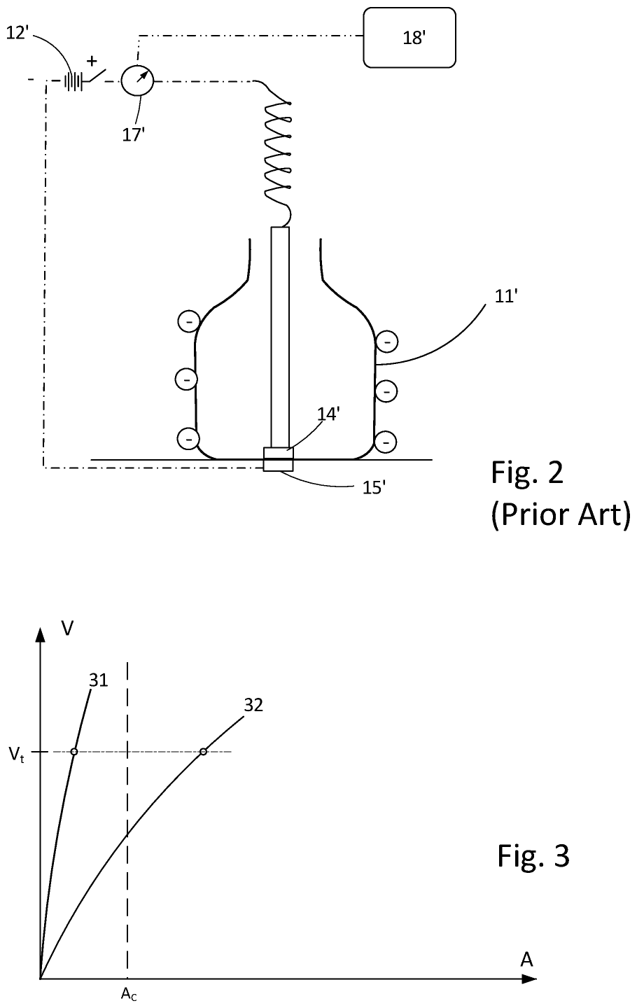

FIG. 2 shows a prior art configuration, which is a similar arrangement to FIG. 1B with the major exception that the poles of the battery has been switched, meaning that the electrode outside the container is connected to the negative side of the battery (cathode) while the electrode inside the container is connected to the positive side (anode). This exemplary configuration leads to build-up of negative charges on the outside wall of the container and the disadvantages inherent thereby, and is not consistent with the disclosed inventive embodiments. In FIG. 2, all like elements have been given the same reference numbers as in FIGS. 1A and 1B and designated “prime”. As shown, the first electrode (anode) 14′ is on the inside of the container, and the second electrode (cathode) 15′ is on the outside of the container in FIG. 2.

FIG. 3 shows the correlation between voltage (V) and current (A) for two measurements, representing measurement performed on two different containers. The first line 31 shows a high voltage applied with a very modest current related thereto. The entire line is to the left of the dotted line marked A_{C}, defining the current limitation for products in compliance with the product requirement. The second line 32, however, shows that the voltage applied generated a substantial current that exceeded the compliance limit indicated by the dotted line. The product represented by the second line therefore had to be destroyed/recycled. It should be noted, however, that it is not a requirement of the disclosed embodiments to establish such complete lines from low to high voltage in order to test the products. It is sufficient to test at a specific voltage, such as that indicted by the voltage level Vₜ in FIG. 3.

The disclosed method and instrumentation utilize these principles and are configured to leak test containers (11) by first placing the first electrode (14) (anode) on the outside of the container wall and the second electrode (15) (cathode) on the inside of the container wall. A high voltage is applied between them. The current between the first electrode (14) and the second electrode (15) is detected and a processing unit determines whether the detected current is above a predetermined threshold (A_{C}). The relative positioning of the cathode and anode in the disclosed method and device has been shown to reduce or eliminate buildup of negative charge on the outside of the containers, which carries numerous drawbacks.

The wall of the containers (11) typically have a thickness within a range of 0.3 mm to 3.0 mm, more preferably within a range of 0.4 mm to 2 mm, and even more preferably within a range of 0.5 mm to 1 mm.

The wall of the containers (11) may be formed from the non-limiting list of polyethylene terephthalate (PET), high density polyethylene (HDPE), and polypropylene (PP). The container walls may have at least one barrier layer, which may be a gas barrier layer, solvent barrier layer, fragrance barrier layer, or combinations thereof. The wall may additionally include one or more fillers and/or one or more fibers.

The applied voltage may be less than 10 kV/0.1 mm, more preferably less than 8 kV/0.1 mm, and even more preferably less than 5 kV/0.1 mm.

It should be noted that the drawings only present the principles of the present invention and that the scale of the drawings may deviate significantly from real-life embodiments.

What is claimed is:

1. A method for leak testing of blow molded plastic containers (11) having a wall separating an outside from an inside, comprising the steps of:
(a) placing a first electrode (14) on the outside of the container wall;
(b) placing a second electrode (15) on the inside of the container wall;
(c) applying high voltage between the first electrode (14) and the second electrode (15);
(d) detecting a current between the first electrode (14) and the second electrode (15);
(e) determining whether the current detected in step (d) is above a predetermined threshold (A_{C}), wherein
the first electrode (14) is the anode and the second electrode (15) is the cathode.

2. The method of claim 1, wherein the wall of the container (11) has a thickness within a range of 0.3 mm to 3.0 mm.

3. The method of claim 1, wherein the wall of the container (11) has a thickness within a range of 0.4 mm to 2 mm.

4. The method of claim 1, wherein the wall of the container (11) has a thickness within a range of 0.5 mm to 1 mm.

5. The method of claim 1, wherein the wall of the container (11) comprises a thermoplastic material selected from the group consisting of polyethylene terephthalate (PET), high density polyethylene (HDPE), and polypropylene (PP).

6. The method of claim 2, wherein the wall of the container (11) comprises a thermoplastic material selected from the group consisting of polyethylene terephthalate (PET), high density polyethylene (HDPE), and polypropylene (PP).

7. The method of claim 3, wherein the wall of the container (11) comprises at least one barrier layer selected from the group consisting of gas barrier layer, solvent barrier layer, fragrance barrier layer, and combinations thereof.

8. The method of claim 1, wherein the wall of the container (11) comprises at least one barrier layer selected from the group consisting of gas barrier layer, solvent barrier layer, fragrance barrier layer, and combinations thereof.

9. The method of claim 2, wherein the wall of the container (11) comprises at least one barrier layer selected from the group consisting of gas barrier layer, solvent barrier layer, fragrance barrier layer, and combinations thereof.

10. The method of claim 1, wherein the wall of the container (11) comprises one or more fillers.

11. The method of claim 1, wherein the wall of the container (11) comprises one or more fibers.

12. The method of claim 1, wherein a negative charge on the surface on the outside of a checked container is lower than the negative charge on the surface on the outside of a non-checked container.

13. The method of claim 1, wherein the voltage applied in step (c) is less than 10 kV/0.1 mm.

14. The method of claim 1, wherein the voltage applied in step (c) is less than 8 kV/0.1 mm.

15. The method of claim 1, wherein the voltage applied in step (c) is less than 5 kV/0.1 mm.

16. A device for leak testing of blow molded plastic containers (11) having a wall separating an outside from an inside by using an applied voltage to a wall of the container, comprising:
a unit configured for placing a first electrode (14) on the outside of the wall of the container and a second electrode (15) on the inside of the wall of the container (11);
a power source for applying voltage between the first electrode (14) and the second electrode (15);
a unit for detecting a current between the first electrode (14) and the second electrode (15) and determining whether the detected current is above a pre-determined threshold (A_{C}), wherein
the first electrode (14) is the anode and the second electrode (15) is the cathode.

17. The device according to claim 10, wherein the device is arranged for leak testing a continuous flow of blow molded containers (11).
